(19) United States
(12) Patent Application Publication
(10) Pub. No.: US 2025/0263065 A1
(43) Pub. Date: Aug. 21, 2025

(54) HYBRID VEHICLE AND POWER DETERMINATION METHOD

(71) Applicant: ISUZU MOTORS LIMITED, Yokohama-shi (JP)

(72) Inventor: Sei KAMAKURA, Fujisawa-shi (JP)

(21) Appl. No.: 19/048,116

(22) Filed: Feb. 7, 2025

(30) Foreign Application Priority Data
Feb. 19, 2024 (JP) 2024-022991

(51) Int. Cl. B60W 20/16; B60W 10/06; B60W 10/08

(52) U.S. Cl. CPC B60W 20/16; B60W 10/06; B60W 10/08; B60W 2510/0638; B60W 2510/244; B60W 2540/10; B60W 2710/083

(57) ABSTRACT

A hybrid vehicle includes: a first determination part that determines a fuel injection quantity of an engine and a motor torque generated by a motor on the basis of an opening degree of the accelerator; a second determination part that determines a correction coefficient for correcting the fuel injection quantity and the motor torque on the basis of (i) the temperature of a catalyst that purifies NOx contained in exhaust gas of the engine, by reacting the NOx with ammonia, which is contained in urea water injected into the exhaust gas, and (ii) an SOC of the battery 6 that supplies electricity to the motor; and a calculation part that calculates a corrected fuel injection quantity that is smaller than the fuel injection quantity and a corrected motor torque that is larger than the motor torque on the basis of the correction coefficient.

### CROSS-REFERENCE TO RELATED APPLICATIONS

The present application claims priority to Japanese Patent Application number 2024-022991, filed on Feb. 19, 2024, contents of which are incorporated herein by reference in its entirety.

### BACKGROUND OF THE INVENTION

The present disclosure relates to a hybrid vehicle and a power determination method for determining power of a drive source included in the hybrid vehicle. In a conventional hybrid electric vehicle, a NOx purification rate of a catalyst is improved by controlling the magnitude of motor output and engine output on the basis of the temperature of the catalyst for purifying NOx contained in the exhaust gas and the load required for the hybrid electric vehicle (for example, Japanese Unexamined Patent Application Publication No, 2014-227888).

The catalyst reduces NOx emissions by adsorbing ammonia, which is contained in urea water injected into the exhaust gas, and reacting NOx contained in the exhaust gas with the ammonia to reduce NOx to nitrogen and water. The higher the temperature of the catalyst, the less the amount of ammonia that can be adsorbed by the catalyst. Therefore, when an amount of change in output when increasing the engine output is large, the temperature of the catalyst also rapidly rises with the rapid rise of the exhaust gas temperature, so that the amount of ammonia that can be adsorbed by the catalyst rapidly decreases, and thus ammonia is desorbed from the catalyst and emitted.

### BRIEF SUMMARY OF THE INVENTION

The present disclosure has been made in view of these points, and its object is to suppress the emission of ammonia.

A hybrid vehicle according to a first aspect of the present disclosure including: a first determination part that determines a fuel injection quantity of an engine and a motor torque generated by a motor on the basis of an opening degree of an accelerator; a second determination part that determines a correction coefficient for correcting the fuel injection quantity and the motor torque on the basis of (i) a temperature of a catalyst that purifies NOx contained in exhaust gas of the engine, by reacting the NOx with ammonia, which is contained in urea water injected into the exhaust gas, and (ii) a charging rate of a battery that supplies electricity to the motor; and a calculation part that calculates a corrected fuel injection quantity that is smaller than the fuel injection quantity and a corrected motor torque that is larger than the motor torque on the basis of the correction coefficient.

The second determination part may increase the correction coefficient as the temperature of the catalyst decreases, and the calculation part may decrease the corrected fuel injection quantity and increase the corrected motor torque, as the correction coefficient increases.

### BRIEF DESCIRPTION OF THE DRAWINGS

FIG. 1 illustrates an outline of a hybrid vehicle S according to the present embodiment.

FIG. 2 shows a configuration of the vehicle S.

FIG. 3 illustrates a corrected fuel injection quantity and a corrected motor torque.

FIG. 4 is an example of a processing sequence in a power determination apparatus 20.

FIG. 5 illustrates an operation of the vehicle S according to a first modification example.

FIG. 6 illustrates an operation of the vehicle S according to a second modification example.

FIG. 7 illustrates an operation of the vehicle S according to a third modification example.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### Outline of a Hybrid Vehicle S

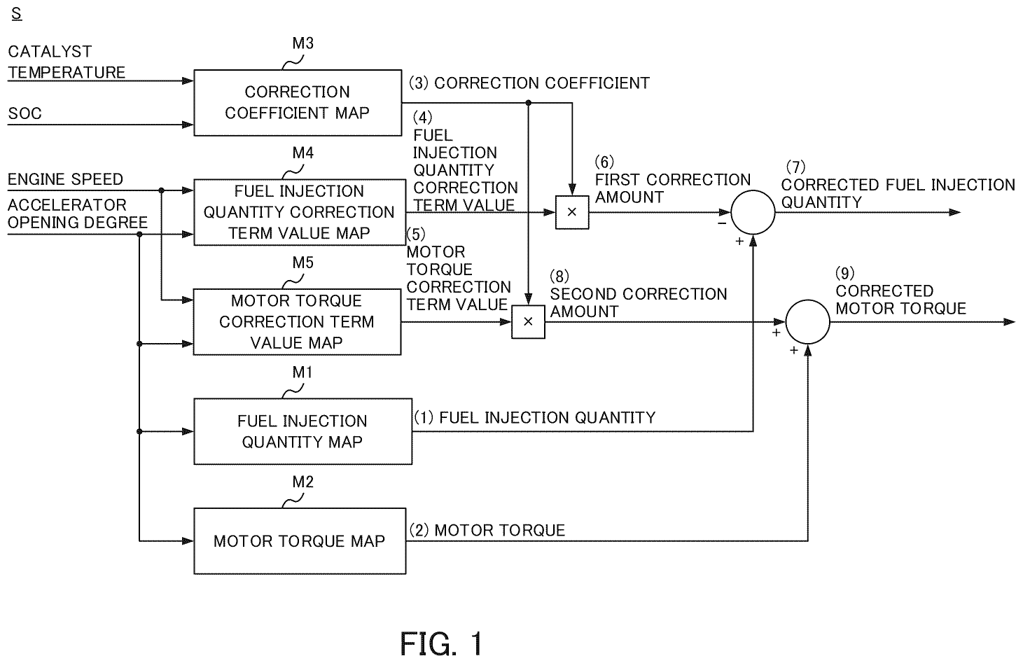

FIG. 1 illustrates an outline of a hybrid vehicle S (hereinafter, referred to as a “vehicle S”) according to the present embodiment. The vehicle S includes an engine and a motor as drive sources, and has a function of determining an injection quantity of fuel supplied to the engine and a torque generated by the motor. For example, the vehicle S determines a corrected fuel injection quantity obtained by correcting the injection quantity of the fuel based on an accelerator opening degree and a corrected motor torque obtained by correcting the torque of the motor on the basis of the accelerator opening degree, based on (i) a charging rate of a battery that supplies electricity to the motor and (ii) the temperature of the catalyst. Then, the vehicle S causes the engine to inject fuel with the determined corrected fuel injection quantity, and causes the motor to generate the determined corrected motor torque.

The accelerator opening degree indicates a pedal depression amount by which a driver of the vehicle S presses an accelerator pedal. In the following description, the injection quantity of fuel based on the accelerator opening degree is referred to as a “fuel injection quantity”, the torque of the motor based on the accelerator opening degree is referred to as a “motor torque”, the state of charge rate of the battery is referred to as an “SOC (State Of Charge)”, and the temperature of the catalyst is referred to as a “catalyst temperature”.

The vehicle S includes the catalyst (so-called an SCR (Selective Catalytic Reduction)) for purifying NOx contained in exhaust gas of the engine. The catalyst adsorbs ammonia, which is contained in the urea water injected into the exhaust gas, and reduces NOx contained in the exhaust gas to nitrogen and water by reacting with the ammonia, thereby purifying NOx, for example. The amount of ammonia that can be adsorbed by the catalyst decreases as the temperature of the catalyst increases.

Therefore, for example, when the road on which the vehicle S is traveling changes from a flat road to a road with an uphill slope, the engine output rapidly increases in response to the driver's operation, causing the exhaust gas temperature to rise, and as a result, the catalyst temperature also rises rapidly. This rapid rise in the catalyst temperature significantly reduces the amount of ammonia that the catalyst can absorb. As a result, when the amount of ammonia adsorbed before the catalyst temperature rises exceeds the amount of ammonia that can be adsorbed after the catalyst temperature rises, the catalyst may emit the adsorbed ammonia (causing a phenomenon known as ammonia slip). To address this issue, one possible measure is to increase the motor output instead of the engine output while traveling on an upward slope, but this measure is ineffective in situations where the SOC is reduced.

Therefore, the vehicle S determines a correction coefficient based on the catalyst temperature and the SOC. Then, on the basis of the determined correction coefficient, the vehicle S determines a corrected fuel injection quantity that is smaller than the fuel injection quantity corresponding to the accelerator opening degree and a corrected motor torque that is larger than the motor torque corresponding to the accelerator opening degree. The vehicle S determines the corrected fuel injection quantity and the corrected motor torque such that the sum of the engine output corresponding to the fuel injection quantity and the output of the motor generating the motor torque matches or approximates the sum of the engine output corresponding to the corrected fuel injection quantity and the output of the motor generating the corrected motor torque, for example.

First, the vehicle S determines the fuel injection quantity corresponding to the accelerator opening degree by referencing a fuel injection quantity map M1 ((1) shown in FIG. 1). In the fuel injection quantity map M1, a greater fuel injection quantity corresponds to a greater accelerator opening degree. The vehicle S determines the motor torque corresponding to the accelerator opening degree by referencing the motor torque map M2 ((2) shown in FIG. 1). In the motor torque map M2, a greater motor torque corresponds to a greater accelerator opening degree.

The vehicle S determines a correction coefficient corresponding to the catalyst temperature and the SOC by referencing a correction coefficient map M3 ((3) shown in FIG. 1). The correction coefficient is a coefficient for correcting the fuel injection quantity and the motor torque, and the correction coefficient map M3 indicates the correction coefficient corresponding to the catalyst temperature and the SOC. The correction coefficient and the correction coefficient map M3 will be described later.

By referencing a fuel injection quantity correction term value map M4, the vehicle S determines a fuel injection quantity correction term value corresponding to the accelerator opening degree and an engine speed ((4) shown in FIG. 1). By referencing a motor torque correction term value map M5, the vehicle S determines a motor torque correction term value corresponding to the accelerator opening degree and the engine speed ((5) shown in FIG. 1). The fuel injection quantity correction term value, the motor torque correction term value, the fuel injection quantity correction term value map M4, and the motor torque correction term value map M5 will be described later.

Next, the vehicle S calculates, as a first correction amount, a multiplication value obtained by multiplying the fuel injection quantity correction term value by the correction coefficient ((6) shown in FIG. 1), and determines, as the corrected fuel injection quantity, a subtraction value obtained by subtracting the first correction amount from the fuel injection quantity ((7) shown in FIG. 1). The vehicle S calculates, as a second correction amount, a multiplication value obtained by multiplying the motor torque correction term value by the correction coefficient ((8) shown in FIG. 1), and determines, as the corrected motor torque, an addition value obtained by adding the second correction amount to the motor torque ((9) shown in FIG. 1).

By operating as described above, the vehicle S can increase the engine output in a manner that prevents the catalyst temperature from rising rapidly when the catalyst temperature is in a lowered state. As a result, the vehicle S can suppress a decrease in the SOC while also suppressing the occurrence of ammonia slip. Since the vehicle S has suppressed the decrease in the SOC, it can increase the motor output when ammonia slip is likely to occur, thereby suppressing ammonia slip. Furthermore, when the catalyst temperature and the SOC are high, the vehicle S can suppress an increase in the catalyst temperature by increasing the motor output relative to the engine output, thereby suppressing ammonia slip. Hereinafter, the configuration and operation of the vehicle S will be described in detail.

### Configuration of the Vehicle S

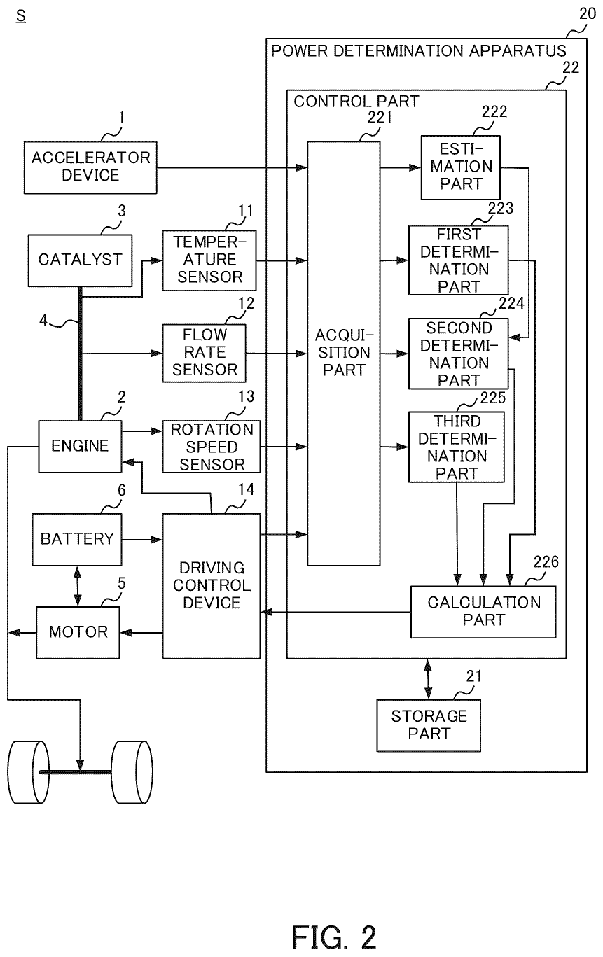

FIG. 2 illustrates a configuration of the vehicle S. The vehicle S shown in FIG. 2 includes an accelerator device 1, an engine 2, a catalyst 3, an exhaust passage 4, a motor 5, a battery 6, a temperature sensor 11, a flow rate sensor 12, a rotation speed sensor 13, a driving control device 14, and a power determination apparatus 20. FIG. 2 shows, as an example, a case where the accelerator opening degree is a pedal depression amount of an accelerator pedal.

The accelerator device 1 is a device for controlling acceleration of the vehicle S. The accelerator device 1 includes, for example, the accelerator pedal and a pedal sensor, and the pedal sensor detects the pedal depression amount indicating an amount that a driver of the vehicle S steps on the accelerator pedal. The accelerator device 1 outputs the detected pedal depression amount to the power determination apparatus 20 as the accelerator opening degree.

The engine 2 is a drive source of the vehicle S, and is an internal combustion engine that generates power by combusting and expanding a mixture of fuel and intake air (air). The catalyst 3 is a purification device for purifying the exhaust gas of the engine 2 flowing through the exhaust passage 4, which is provided downstream of the engine 2 in the exhaust passage 4, and includes, for example, an SCR. The catalyst 3 purifies NOx contained in the exhaust gas of the engine 2 by reacting the NOx with ammonia, which is contained in the urea water injected into the exhaust gas. The exhaust passage 4 is a passage through which the exhaust gas of the engine 2 flows to the catalyst 3.

The motor 5 is a drive source of the vehicle S, and is an electric motor that generates power by electricity supplied from the battery 6 via an inverter (not shown). The motor 5 may cause the battery 6 to store electricity generated by operating as a generator (so-called regenerative braking) when braking the vehicle S. The battery 6 is a rechargeable storage battery and supplies electricity to the motor 5. The battery 6 stores, for example, electricity supplied from an external source of the vehicle S, electricity generated by the motor 5, and electricity generated by a solar panel (not shown) included on the vehicle S.

The temperature sensor 11 is a sensor that is provided upstream of the catalyst 3 in the exhaust passage 4, detects the temperature of an inlet through which exhaust gas flows into the catalyst 3, and outputs the detected temperature to the power determination apparatus 20. The flow rate sensor 12 is a sensor for detecting a flow rate of exhaust gas flowing through the exhaust passage 4 (hereinafter referred to as “exhaust flow rate”) and outputting the flow rate to the power determination apparatus 20. The rotation speed sensor 13 is a sensor for detecting the rotation speed of the engine 2 and outputting the rotation speed to the power determination apparatus 20.

The driving control device 14 is, for example, a device including one or more processors such as central processing units (CPUs) or electronic control units (ECUs), and a storage part. The driving control device 14 causes the processor to execute programs stored in the storage part, thereby causing the engine 2 to inject fuel with the corrected fuel injection quantity determined by the power determination apparatus 20, and causing the motor 5 to generate the corrected motor torque determined by the power determination apparatus 20. The driving control device 14 acquires the charge rate of the battery 6 and provides notification about the charge rate to the power determination apparatus 20.

The power determination apparatus 20 is, for example, a device including one or more processors such as the CPU or the ECU. The power determination apparatus 20 determines the corrected fuel injection quantity and the corrected motor torque on the basis of, for example, the accelerator opening degree acquired from the accelerator device 1, the temperature acquired from the temperature sensor 11, and the SOC acquired from the driving control device 14. The power determination apparatus 20 provides notification about the determined corrected fuel injection quantity and corrected motor torque to the driving control device 14, thereby causing the engine 2 to inject fuel with the corrected fuel injection quantity, and causing the motor 5 to generate the corrected motor torque. The power determination apparatus 20 may have a housing including electronic components, or may be a printed substrate on which the electronic components are mounted. The power determination apparatus 20 may include the driving control device 14. The configuration and operation of the power determination apparatus 20 will be described in detail below.

### Configuration of the Power Determination Apparatus 20

As shown in FIG. 2, the power determination apparatus 20 includes a storage part 21 and a control part 22. The control part 22 includes an acquisition part 221, an estimation part 222, a first determination part 223, a second determination part 224, a third determination part 225, and a calculation part 226.

The storage part 21 includes, for example, a storage medium such as a read only memory (ROM), a random access memory (RAM), a hard disk drive (HDD), or a solid state drive (SSD). The storage part 21 stores programs executed by the control part 22 and various types of information for determining the corrected fuel injection quantity and the corrected motor torque. As an example, the storage part 21 stores the fuel injection quantity map M1, a motor torque map M2, a correction coefficient map M3, a fuel injection quantity correction term value map M4, and a motor torque correction term value map M5 shown in FIG. 1.

The control part 22 is, for example, a processor such as a CPU or an ECU. The control part 22 functions as the acquisition part 221, the estimation part 222, the first determination part 223, the second determination part 224, the third determination part 225, and the calculation part 226 by executing the programs stored in the storage part 21. The control part 22 may be configured by a single processor, or may be configured by a plurality of processors or a combination of one or more processors and an electronic circuit. A configuration of each part implemented by the control part 22 will be described below.

The acquisition part 221 acquires various types of information from the external source of the power determination apparatus 20 at a predetermined control cycle. The control cycle is, for example, 0.1 seconds. For example, the acquisition part 221 acquires the accelerator opening degree from the accelerator device 1, the temperature of the inlet of the catalyst 3 from the temperature sensor 11, the flow rate of the exhaust gas flowing through the exhaust passage 4 from the flow rate sensor 12, the rotation speed of the engine 2 from the rotation speed sensor 13, and the SOC of the battery 6 from the driving control device 14. The acquisition part 221 stores, for example, various kinds of acquired information in the storage part 21.

The estimation part 222 estimates the temperature of the catalyst 3 (catalyst temperature). The estimation part 222 estimates the catalyst temperature on the basis of, for example, the temperature of the inlet through which the exhaust gas flows into the catalyst 3 and the flow rate of the exhaust gas. For example, the estimation part 222 acquires the temperature detected by the temperature sensor 11 and the flow rate of the exhaust gas detected by the flow rate sensor 12 from the acquisition part 221, and estimates the catalyst temperature as a result of the exhaust gas, which has the acquired temperature and flow rate, coming into contact with the catalyst 3. The estimation part 222 may estimate the temperature detected by the temperature sensor 11 as the catalyst temperature.

The first determination part 223 determines a fuel injection quantity of the engine 2 and the motor torque generated by the motor 5 on the basis of the accelerator opening degree. For example, the first determination part 223 determines the fuel injection quantity of the engine 2 corresponding to the accelerator opening degree acquired by the acquisition part 221 by referencing the fuel injection quantity map M1 stored in the storage part 21 ((1) shown in FIG. 1). For example, the first determination part 223 determines the motor torque corresponding to the accelerator opening degree acquired by the acquisition part 221 by referencing the motor torque map M2 stored in the storage part 21 ((2) shown in FIG. 1).

The second determination part 224 determines a correction coefficient for correcting the fuel injection quantity and the motor torque on the basis of the catalyst temperature and the SOC of the battery 6. The correction coefficient is a coefficient for calculating the first correction amount of the fuel injection quantity and the second correction amount of the motor torque, and is, for example, a coefficient indicating a value equal to or greater than 0. The second determination part 224 determines a correction coefficient corresponding to the catalyst temperature estimated by the estimation part 222 and the SOC of the battery 6 acquired by the acquisition part 221 from the driving control device 14, for example, by referencing the correction coefficient map M3 stored in the storage part 21 ((3) shown in FIG. 1).

For example, the second determination part 224 references the correction coefficient map M3, which is stored in the storage part 21 and includes correction coefficients that indicate larger values as the catalyst temperature decreases. Based on this map, the second determination part 224 increases the correction coefficient as the catalyst temperature decreases. Since the second determination part 224 determines the correction coefficient in this manner, the vehicle S can reduce the corrected fuel injection quantity and increase the corrected motor torque as the catalyst temperature decreases. Therefore, even when the vehicle S rapidly increases the output of the engine 2 while the catalyst temperature is in the lowered sate, the second determination part 224 can suppress a rapid rise in exhaust gas temperature by gradually increasing the fuel injection quantity, thereby preventing the rapid increase in the catalyst temperature. Consequently, the second determination part 224 can suppress the occurrence of ammonia slip caused by the rapid rise in the catalyst temperature.

For example, the second determination part 224 increases the correction coefficient as the SOC of the battery 6 increases. That is, the correction coefficient map M3 includes correction coefficients that indicate larger values as the SOC increases. Since the second determination part 224 determines the correction coefficient in this manner, the second determination part 224 can reduce the corrected fuel injection quantity and increase the corrected motor torque as the SOC of the battery 6 increases. As a result, when the SOC of the battery 6 is high, the second determination part 224 can suppress an increase in the catalyst temperature by reducing the output of the engine 2, thereby suppressing the occurrence of ammonia slip.

The third determination part 225 determines (i) a fuel injection quantity correction term value for correcting the fuel injection quantity and (ii) a motor torque correction term value for correcting the motor torque, on the basis of the rotation speed of the engine 2 and the accelerator opening degree. The fuel injection quantity correction term value is a term for calculating the first correction amount of the fuel injection quantity, and the motor torque correction term value is a term for calculating the second correction amount of the motor torque.

The third determination part 225 references, for example, the fuel injection quantity correction term value map M4 stored in the storage part 21 to determine a fuel injection quantity correction term value corresponding to the engine speed and the accelerator opening degree of the engine 2, acquired by the acquisition part 221 ((4) shown in FIG. 1). The fuel injection quantity correction term value map M4 includes a fuel injection quantity correction term value corresponding to the rotation speed of the engine 2 and the accelerator opening degree, and indicates a fuel injection quantity correction term value for increasing the first correction amount as the rotation speed of the engine 2 and the accelerator opening degree increase. For example, by referencing the fuel injection quantity correction term value map M4, the third determination part 225 determines a fuel injection quantity correction term value for determining a greater first correction amount as the rotation speed of the engine 2 and the accelerator opening degree increase.

The third determination part 225 references, for example, the motor torque correction term value map M5 stored in the storage part 21 to determine a motor torque correction term value corresponding to the rotation speed of the engine 2 and the accelerator opening degree acquired by the acquisition part 221 ((5) shown in FIG. 1). The motor torque correction term value map M5 includes a motor torque correction term value corresponding to the rotation speed of the engine 2 and the accelerator opening degree. The motor torque correction term value map M5 indicates a motor torque correction term value for increasing the second correction amount as the rotation speed of the engine 2 and the accelerator opening degree increase. For example, by referencing the motor torque correction term value map M5, the third determination part 225 determines a motor torque correction term value for determining a greater second correction amount as the rotation speed of the engine 2 and the accelerator opening degree increase.

The magnitude of the rotation speed of the engine 2 corresponds to the exhaust flow rate at the current time, while the magnitude of the accelerator opening degree corresponds to the exhaust flow rate after a predetermined time has passed from the current time. The higher the exhaust gas flow rate, the higher the catalyst temperature. Accordingly, it can be said that the fuel injection quantity correction term value map M4 includes the fuel injection quantity correction term value that corresponds to both the amount of change in the catalyst temperature after the predetermined time from the current time and the catalyst temperature at the current time, and the motor torque correction term value map M5 includes the motor torque correction term value that corresponds to the amount of change in the catalyst temperature after the predetermined time from the current time and the catalyst temperature at the current time. Therefore, by referencing the fuel injection quantity correction term value maps M4 and M5, the third determination part 225 can determine the fuel injection quantity correction term value and the motor torque correction term value that correspond to the amount of change in the catalyst temperature after the predetermined time from the current time and the catalyst temperature at the current time.

The calculation part 226 calculates a corrected fuel injection quantity that is smaller than the fuel injection quantity and a corrected motor torque that is larger than the motor torque, on the basis of the correction coefficient determined by the second determination part 224. For example, the calculation part 226 decreases the corrected fuel injection quantity and increases the corrected motor torque as the correction coefficient increases.

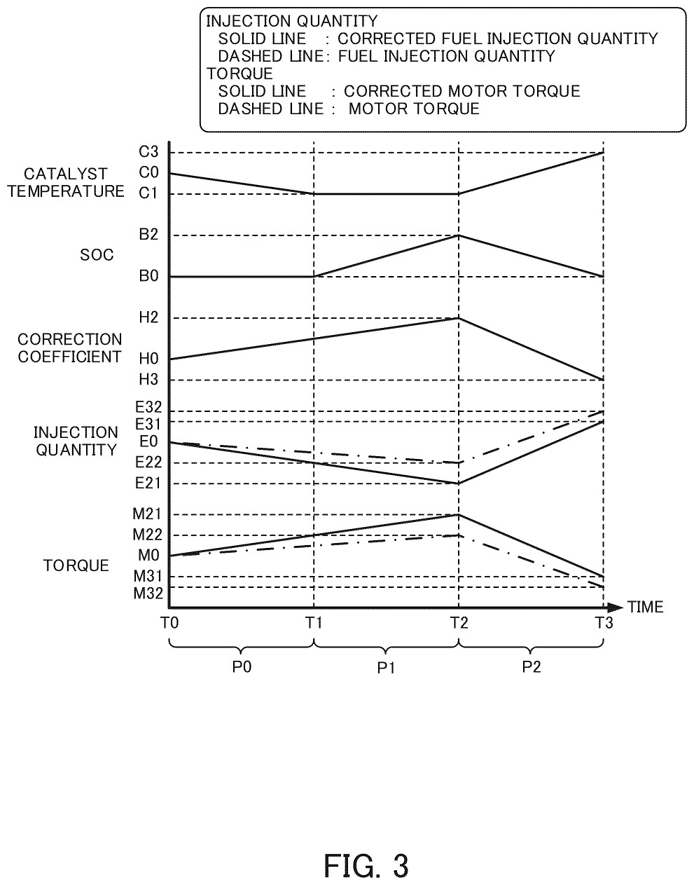

FIG. 3 is a diagram for explaining the corrected fuel injection quantity and the corrected motor torque. The horizontal axis of FIG. 3 represents time, and the vertical axis of FIG. 3 represents the “catalyst temperature” of the catalyst 3, the “SOC” of the battery 6, the “correction coefficient” determined by the second determination part 224, the “injection quantity”, and the “torque”. In the “injection quantity” shown in FIG. 3, a solid line indicates the corrected fuel injection quantity ((7) shown in FIG. 1), and a dashed line indicates the fuel injection quantity ((1) shown in FIG. 1). In the “torque” shown in FIG. 3, a solid line indicates the corrected motor torque ((9) shown in FIG. 1), and a dashed line indicates the motor torque ((2) shown in FIG. 1). The time periods (a time period P0 and a time period P1) before a time T2 shown in FIG. 3 are when the vehicle S travels on a flat road, and a time period P2 after the time T2 is when the vehicle S travels on the road with an uphill slope. In the time period P1 shown in FIG. 3, the SOC increases due to deceleration or stopping of the vehicle S, or power generation by a solar panel included on the vehicle S.

As illustrated in FIG. 3, during the time periods P0 and P1, the second determination part 224 increases the correction coefficient from a coefficient H0 to a coefficient H2 because the catalyst temperature decreases from a temperature C0 to a temperature C1, and the SOC increases from a state of charge B0 to a state of charge B2. Then, for example, at the time T2, the calculation part 226 calculates a corrected fuel injection quantity E21, which is smaller than a fuel injection quantity E22 determined by the first determination part 223, and calculates a corrected motor torque M21, which is larger than a motor torque M22 determined by the first determination part 223.

Next, during the time period P2, the second determination part 224 decreases the correction coefficient from the coefficient H2 to a coefficient H3 because the catalyst temperature increases from the temperature C1 to a temperature C3, and the SOC decreases from state of charge B2 to the state of charge B0. Then, for example, at a time T3, the calculation part 226 calculates a corrected fuel injection quantity E31, which is smaller than a fuel injection quantity E32 determined by the first determination part 223, and a corrected motor torque M31, which is larger than a motor torque M32 determined by the first determination part 223.

During the time periods P0, P1, and P2 shown in FIG. 3, a difference “E22-E21” between the fuel injection quantity and the corrected fuel injection quantity at the time T2, where the correction coefficient is at its maximum, is larger than a difference between the fuel injection quantity and the corrected fuel injection quantity at other times. That is, the calculation part 226 calculates the corrected fuel injection quantity, which decreases relative to the fuel injection quantity as the correction coefficient increases. A difference “M21-M22” between the corrected motor torque and the motor torque at the time T2 is also larger than a difference between the corrected motor torque and the motor torque at other times. That is, the calculation part 226 calculates the corrected motor torque, which increases relative to the motor torque as the correction coefficient increases.

Since the calculation part 226 operates as described above, it can reduce the corrected fuel injection quantity and increase the corrected motor torque when the correction coefficient increases due to a decrease in the catalyst temperature (e.g., the time period P0 shown in FIG. 3). Therefore, when the catalyst temperature is in the lowered state, the calculation part 226 can make the output of the engine 2 smaller than the output of the motor 5. As a result, by increasing the motor output, the calculation part 226 can reduce the likelihood of ammonia slip, which is likely to occur due to a sudden increase in the fuel injection quantity.

Furthermore, when the correction coefficient is large due to a high SOC, the calculation part 226 can reduce the corrected fuel injection quantity and increase the corrected motor torque (e.g., the time period P1 shown in FIG. 3). Therefore, the calculation part 226 can drive the vehicle S by increasing the output of the motor 5 because the SOC is high, even when, for example, a large output is required to travel on a road with an uphill slope during the time period P2. Thus, the output of the engine 2 can be suppressed. As a result, the calculation part 226 can suppress an increase in the catalyst temperature, thereby suppressing ammonia slip.

The calculation part 226 calculates, for example, a corrected fuel injection quantity ((7) shown in FIG. 1) obtained by subtracting, from the fuel injection quantity, the first correction amount ((6) shown in FIG. 1) obtained by multiplying the fuel injection quantity correction term value by the correction coefficient. For example, the calculation part 226 calculates the first correction amount by multiplying the fuel injection quantity correction term value by the correction coefficient after substituting the correction coefficient, which is determined by the second determination part 224, into the coefficient included in the fuel injection quantity correction term value. The calculation part 226 then calculates the corrected fuel injection quantity by subtracting the first correction amount from the fuel injection quantity.

For example, the calculation part 226 calculates the corrected motor torque ((9) shown in FIG. 1) obtained by adding, to the motor torque, the second correction amount ((8) shown in FIG. 1) obtained by multiplying the motor torque correction term value by the correction coefficient. For example, the calculation part 226 calculates the second correction amount by multiplying the motor torque correction term value by the correction coefficient after substituting the correction coefficient, which is determined by the second determination part 224, into the coefficient included in the motor torque correction term value. The calculation part 226 then calculates the corrected motor torque by adding the second correction amount to the motor torque.

Since the calculation part 226 operates as described above, the calculation part 226 can use the fuel injection quantity correction term value and the motor torque correction term value that correspond to (i) the rotation speed of the engine 2 corresponding to the catalyst temperature at the current time and (ii) the accelerator opening degree corresponding to the catalyst temperature after the predetermined time from the current time. As a result, the calculation part 226 can calculate the corrected fuel injection quantity and the corrected motor torque corresponding to the catalyst temperature at the current time and the amount of change in the catalyst temperature after the predetermined time from the current time, thereby improving the accuracy of suppressing ammonia slip.

The calculation part 226 outputs the calculated corrected fuel injection quantity and the corrected motor torque to the driving control device 14, thereby causing the engine 2 to inject fuel at the corrected fuel injection quantity and causing the motor 5 to generate the corrected motor torque.

### Processing Sequence in the Power Determination Apparatus 20

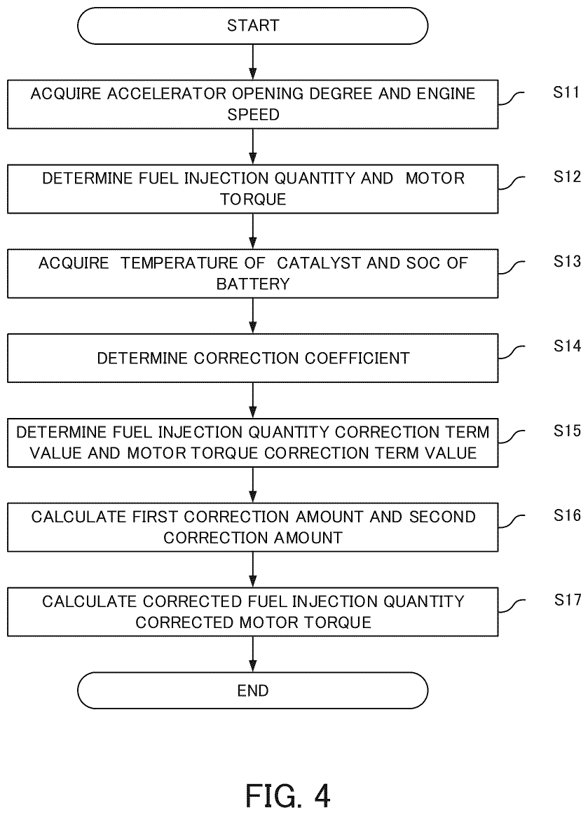

FIG. 4 is a diagram illustrating an example of a processing sequence in the power determination apparatus 20. The processing sequence shown in FIG. 4 shows an operation of calculating the corrected fuel injection quantity and the corrected motor torque by the power determination apparatus 20 executing the operations shown in FIG. 1. The power determination apparatus 20 executes the processing sequence shown in FIG. 4 at a predetermined control cycle.

The acquisition part 221 acquires an accelerator opening degree from the accelerator device 1 and acquires an engine speed from the rotation speed sensor 13 (S11). The first determination part 223 determines a fuel injection quantity ((1) shown in FIG. 1) corresponding to the accelerator opening degree acquired by the acquisition part 221 and the motor torque ((2) shown in FIG. 1) corresponding to the accelerator opening degree (S12).

The acquisition part 221 acquires the temperature of the catalyst 3 from the temperature sensor 11, and acquires the SOC of the battery 6 from the driving control device 14 (S13). The second determination part 224 determines a correction coefficient ((3) shown in FIG. 1) on the basis of (i) the SOC acquired by the acquisition part 221 and (ii) the catalyst temperature estimated by the estimation part 222 on the basis of the temperature of the catalyst 3 acquired by the acquisition part 221 (S14). The third determination part 225 determines a fuel injection quantity correction term value ((4) shown in FIG. 1) and a motor torque correction term value ((5) shown in FIG. 1) on the basis of the accelerator opening degree and the engine speed acquired by the acquisition part 221 (S15).

The calculation part 226 calculates a first correction amount ((6) shown in FIG. 1) by substituting the correction coefficient determined by the second determination part 224 into the coefficient included in the fuel injection quantity correction term value determined by the third determination part 225 (S16). For example, the calculation part 226 determines, as the first correction amount, a multiplication value obtained by multiplying the fuel injection quantity correction term value by the correction coefficient. The calculation part 226 calculates a second correction amount ((8) shown in FIG. 1) by substituting the correction coefficient into the coefficient included in the motor torque correction term value determined by the third determination part 225 (S16). For example, the calculation part 226 determines, as the second correction amount, a multiplication value obtained by multiplying the motor torque correction term value by the correction coefficient. The calculation part 226 calculates a corrected fuel injection quantity ((7) shown in FIG. 1) obtained by subtracting the first correction amount from the fuel injection quantity and a corrected motor torque ((9) shown in FIG. 1) obtained by adding the second correction amount to the motor torque (S17), and ends the process.

### First Modification Example

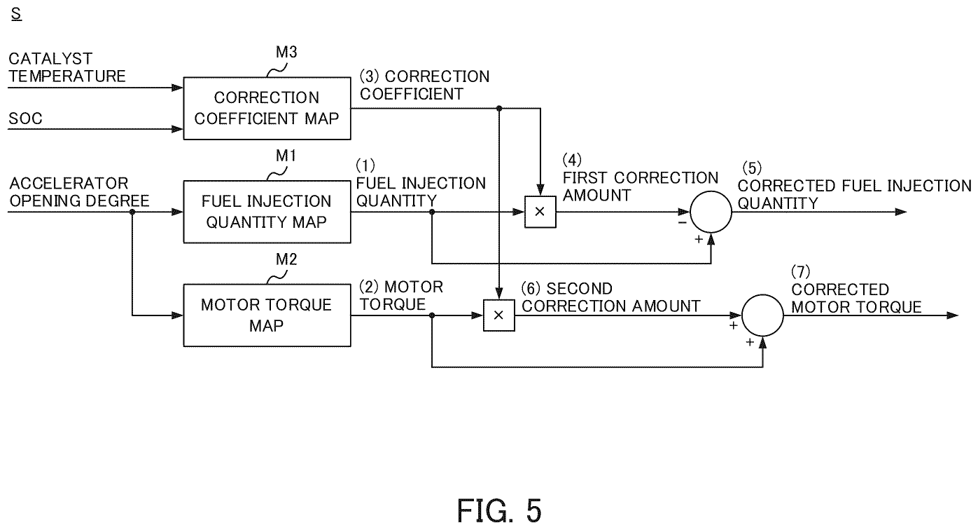

In the above description, the calculation part 226 calculates the first correction amount obtained by multiplying the fuel injection quantity correction term value by the correction coefficient, and the second correction amount obtained by multiplying the motor torque correction term value by the correction coefficient, but the present disclosure is not limited thereto. The calculation part 226 may calculate the first correction amount and the second correction amount without relying on the fuel injection quantity correction term value and the motor torque correction term value. FIG. 5 is a diagram illustrating an operation of the vehicle S according to a first modification example. The vehicle S shown in FIG. 5 differs from the vehicle S shown in FIG. 1 in two ways: (i) it does not include the fuel injection quantity correction term value map M4 and the motor torque correction term value map M5, and (ii) it includes (4) and (6) shown in FIG. 5. In all other respects, the two vehicles are the same.

The calculation part 226 calculates, for example, a corrected fuel injection quantity ((5) shown in FIG. 5) obtained by subtracting, from the fuel injection quantity, a first correction amount ((4) shown in FIG. 5) obtained by multiplying the fuel injection quantity by the correction coefficient. The calculation part 226 calculates, for example, a corrected motor torque ((7) shown in FIG. 5) obtained by adding, to the motor torque, a second correction amount ((6) shown in FIG. 5) obtained by multiplying the motor torque by a correction coefficient. Since the calculation part 226 operates in this manner, the vehicle S can reduce the computation load required to calculate the corrected fuel injection quantity and the corrected motor torque.

### Second Modification Example

In the above description, the operation where the second determination part 224 determines a single correction coefficient for calculating the corrected fuel injection quantity and the corrected motor torque is exemplified, but the present disclosure is not limited thereto. The second determination part 224 may determine two correction coefficients. Specifically, the second determination part 224 may determine a first correction coefficient for correcting the fuel injection quantity and a second correction coefficient for correcting the motor torque.

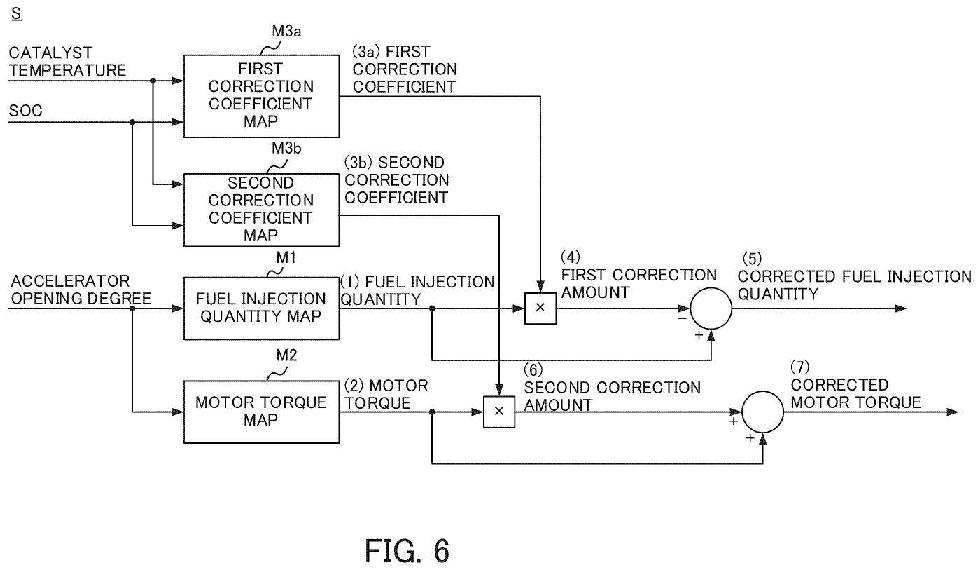

FIG. 6 is a diagram illustrating an operation of the vehicle S according to a second modification example. The vehicle S shown in FIG. 6 differs from the vehicle S shown in FIG. 5 in two ways: (i) it includes a first correction coefficient map M3a and a second correction coefficient map M3b, and (ii) it includes (3a) and (3b) shown in FIG.

6. In all other respects, the two vehicles are the same. Similarly to the correction coefficient map M3 shown in FIG. 5, the first correction coefficient map M3a and the second correction coefficient map M3b shown in FIG. 6 are maps that include correction coefficients corresponding to the SOC of the battery 6 and the catalyst temperature, and include correction coefficients that indicate larger values as the catalyst temperature decreases and the SOC increases.

The second determination part 224 determines a first correction coefficient corresponding to the catalyst temperature and the SOC, for example, by referencing the first correction coefficient map M3a stored in the storage part 21 ((3a) shown in FIG. 6). The second determination part 224 determines a second correction coefficient corresponding to the catalyst temperature and the SOC, for example, by referencing the second correction coefficient map M3b stored in the storage part 21 ((3b) shown in FIG. 6).

The calculation part 226 calculates a corrected fuel injection quantity on the basis of the first correction coefficient, and calculates a corrected motor torque on the basis of the second correction coefficient. For example, the calculation part 226 calculates a first correction amount by multiplying the fuel injection quantity by the first correction coefficient ((4) shown in FIG. 6), and calculates the corrected fuel injection quantity by subtracting the first correction amount from the fuel injection quantity ((5) shown in FIG. 6). For example, the calculation part 226 calculates a second correction amount by multiplying the motor torque by the second correction coefficient ((6) shown in FIG. 6), and calculates the corrected motor torque by adding the second correction amount to the motor torque ((7) shown in FIG. 6).

Since the second determination part 224 determines the correction coefficients as described above, the calculation part 226 can multiply the fuel injection quantity and the motor torque respectively by different correction coefficients. As a result, the calculation part 226 can easily adjust the first correction amount for the corrected fuel injection quantity and the second correction amount for the corrected motor torque.

### Third Modification Example

In the above description, the calculation part 226 calculates the corrected fuel injection quantity obtained by subtracting the first correction amount from the fuel injection quantity and the corrected motor torque obtained by adding the second correction amount to the motor torque, but the present disclosure is not limited to this. The calculation part 226 may calculate a corrected fuel injection quantity obtained by multiplying the fuel injection quantity by a first correction coefficient and a corrected motor torque obtained by multiplying the motor torque by a second correction coefficient.

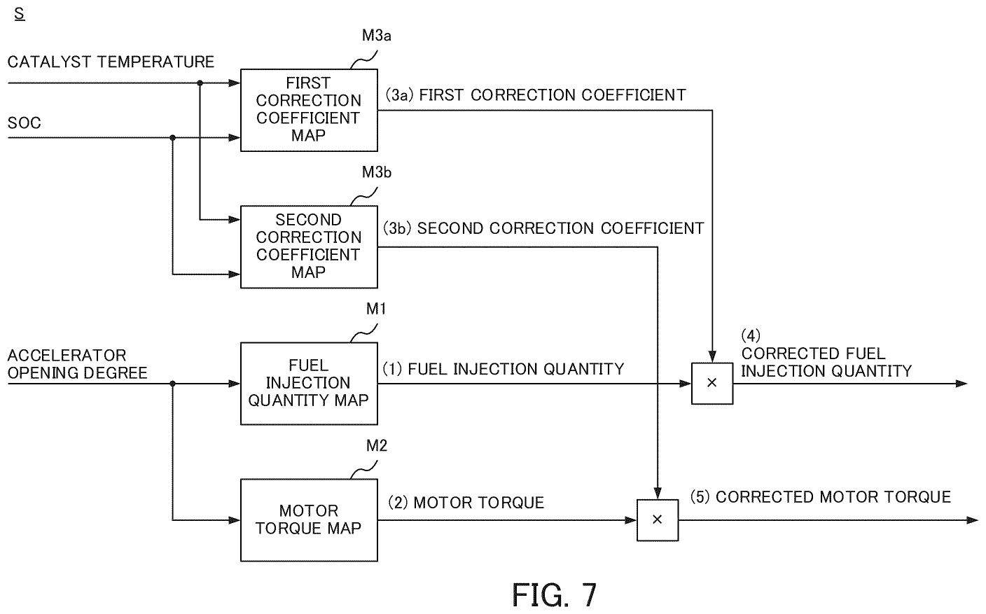

FIG. 7 is a diagram illustrating an operation of the vehicle S according to a third modification example. The vehicle S shown in FIG. 7 differs from the vehicle S shown in FIG. 6 in that it includes (4) and (5) shown in FIG. 7, and is the same in other respects. In FIG. 7, the second determination part 224 determines the first correction coefficient ((3a) shown in FIG. 7) indicating a value greater than or equal to 0 and less than or equal to 1, and determines the second correction coefficient ((3b) shown in FIG. 7) indicating a value greater than or equal to 1, for example.

The calculation part 226 determines a multiplication value obtained by multiplying the fuel injection quantity by the first correction coefficient as the corrected fuel injection quantity ((4) shown in FIG. 7), and determines a multiplication value obtained by multiplying the motor torque by the second correction coefficient as the corrected motor torque ((5) shown in FIG. 7). Since the second determination part 224 and the calculation part 226 operate as described above, the vehicle S can reduce the computation load required to calculate the corrected fuel injection quantity and the corrected motor torque.

### Fourth Modification Example

In the above description, the operation where the second determination part 224 determines the correction coefficient indicating a value equal to or greater than 0 has been exemplified, but the present disclosure is not limited thereto. The second determination part 224 may determine a correction coefficient indicating a value less than 0. In this case, the calculation part 226 calculates, for example, a corrected fuel injection quantity obtained by adding the first correction amount to the fuel injection quantity and a corrected motor torque obtained by subtracting the second correction amount from the motor torque.

### Effects of the Vehicle S

As described above, the vehicle S includes the first determination part 223 that determines the fuel injection quantity of the engine 2 and the motor torque generated by the motor 5 on the basis of the opening degree of the accelerator, the second determination part 224 that determines the correction coefficient for correcting the fuel injection quantity and the motor torque on the basis of (i) the temperature of the catalyst 3 that purifies NOx contained in the exhaust gas of the engine 2, by reacting the NOx with ammonia, which is contained in the urea water injected into the exhaust gas, and (ii) the SOC of the battery 6 that supplies electricity to the motor 5, and the calculation part 226 that calculates the corrected fuel injection quantity that is smaller than the fuel injection quantity and the corrected motor torque that is larger than the motor torque.

With the vehicle S configured in this manner, it can suppress a rapid increase in the output of the engine 2 when the catalyst temperature is in a lowered state, thereby preventing a rapid rise in the catalyst temperature. As a result, the vehicle S can prevent the amount of ammonia that can be adsorbed by the catalyst 3 from rapidly decreasing due to the rapid rise in the catalyst temperature, and suppress emissions of ammonia desorbed from the catalyst 3. Furthermore, when the SOC of the battery 6 is high, the vehicle S can increase the motor output relative to the engine output, and thus can suppress emissions of ammonia desorbed from the catalyst 3.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A hybrid vehicle comprising:
a first determination part that determines a fuel injection quantity of an engine and a motor torque generated by a motor on the basis of an opening degree of an accelerator;
a second determination part that determines a correction coefficient for correcting the fuel injection quantity and the motor torque on the basis of (i) a temperature of a catalyst that purifies NOx contained in exhaust gas of the engine, by reacting the NOx with ammonia, which is contained in urea water injected into the exhaust gas, and (ii) a charging rate of a battery that supplies electricity to the motor; and
a calculation part that calculates a corrected fuel injection quantity that is smaller than the fuel injection quantity and a corrected motor torque that is larger than the motor torque on the basis of the correction coefficient.

2. The hybrid vehicle according to claim 1, wherein
the second determination part increases the correction coefficient as the temperature of the catalyst decreases, and
the calculation part decreases the corrected fuel injection quantity and increases the corrected motor torque, as the correction coefficient increases.

3. The hybrid vehicle according to claim 2, wherein the second determination part increases the correction coefficient as a state of charge of the battery increases.

4. The hybrid vehicle according to claim 1, wherein
the second determination part determines, as the correction coefficient, a first correction coefficient for correcting the fuel injection quantity and a second correction coefficient for correcting the motor torque, and
the calculation part calculates the corrected fuel injection quantity on the basis of the first correction coefficient, and calculates the corrected motor torque on the basis of the second correction coefficient.

5. The hybrid vehicle according to claim 4, wherein
the second determination part determines the first correction coefficient indicating a value greater than or equal to 0 and less than or equal to 1, and determines the second correction coefficient indicating a value greater than or equal to 1.

6. The hybrid vehicle according to claim 1, wherein
the calculation part calculates the corrected fuel injection quantity obtained by subtracting, from the fuel injection quantity, a first correction amount obtained by multiplying the fuel injection quantity by the correction coefficient, and the corrected motor torque obtained by adding, to the motor torque, a second correction amount obtained by multiplying the motor torque by the correction coefficient.

7. The hybrid vehicle according to claim 1, further comprising:
a third determination part that determines a fuel injection quantity correction term value for correcting the fuel injection quantity and a motor torque correction term value for correcting the motor torque, on the basis of an opening degree of the accelerator and a rotation speed of the engine,
the calculation part calculates the corrected fuel injection quantity obtained by subtracting, from the fuel injection quantity, a first correction amount obtained by multiplying the fuel injection quantity correction term value by the correction coefficient, and the corrected motor torque obtained by adding, to the motor torque, a second correction amount obtained by multiplying the motor torque correction term value by the correction coefficient.

8. The hybrid vehicle according to claim 7, wherein
the third determination part determines the fuel injection quantity correction term value for determining a greater first correction amount as the rotation speed of the engine and the opening degree of the accelerator increase.

9. The hybrid vehicle according to claim 7, wherein
the third determination part determines the motor torque correction term value for determining a greater second correction amount as the rotation speed of the engine and the opening degree of the accelerator increase.

10. The hybrid vehicle according to claim 1, further comprising:
an estimation part that estimates the temperature of the catalyst on the basis of a temperature of an inlet through which the exhaust gas flows into the catalyst and a flow rate of the exhaust gas.

11. A power determination method comprising:
a first determination step of determining a fuel injection quantity of an engine and a motor torque generated by a motor on the basis of an opening degree of an accelerator;
a second determination step of determining a correction coefficient for correcting the fuel injection quantity and the motor torque on the basis of (i) a temperature of a catalyst that purifies NOx contained in exhaust gas of the engine, by reacting the NOx with ammonia, which is contained in urea water injected into the exhaust gas, and (ii) a charging rate of a battery that supplies electricity to the motor; and
a calculation step of calculating a corrected fuel injection quantity that is smaller than the fuel injection quantity and a corrected motor torque that is larger than the motor torque on the basis of the correction coefficient.
